(19) United States
(12) Patent Application Publication
(10) Pub. No.: US 2007/0201431 A1
(43) Pub. Date: Aug. 30, 2007

(54) WIRELESS COMMUNICATION DEVICE AND METHOD FOR PROCESSING VOICE OVER INTERNET PROTOCOL SIGNALS THEREOF

(75) Inventors: JR-FU JUANG, Shenzhen (CN); I-NA HSIAO, Shenzhen (CN); CHING-YING CHENG, Shenzhen (CN); MING-JIE YU, Shenzhen (CN); CHIA-CHENG HO, Shenzhen (CN); AN-PANG CHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,723

(22) Filed: Sep. 15, 2006

(30) Foreign Application Priority Data
Feb. 28, 2006 (CN) 200610034075.7

(51) Int. Cl. H04L 12/66

(52) U.S. Cl. 370/352

(57) ABSTRACT

A wireless communication device (10) for processing Voice over Internet Protocol signals includes an encoding and decoding module (30), a central processing unit (CPU) (20), a digital signal processor (DSP) (40), and a wireless communication module (50). The CPU communicates with the encoding and decoding module for controlling signal flows of the wireless communication device, and includes a multi-channel serial interface (MCSI) (200), an external memory interface (EMI) (210), and a serial peripheral interface (SPI) (220). The DSP communicates with the CPU via the MCSI and the EMI for compressing signals received from the MCSI and decompressing signals received from the EMI. The wireless communication module communicates with the CPU via the SPI for receiving and transmitting voice packets.

### FIELD OF THE INVENTION

The invention relates to communication devices, and particularly to a wireless communication device and a method for processing Voice over Internet Protocol (VoIP) signals thereof.

### DESCRIPTION OF RELATED ART

Global system for mobile communications (GSM) and wireless fidelity (WIFI) dual mode phones have functions of Voice over Internet Protocol (VoIP) via wireless local area networks (WLAN). The GSM and WIFI dual mode phones can provide inexpensive long-distance calls in areas of the WLAN, such as airports, hotels, and offices. Therefore, the GSM and WIFI dual mode phones have become more and more popular.

The GSM and WIFI dual mode phones usually have central processing units (CPU) with VoIP functions. The CPUs with VoIP functions are complicated and expensive, and also development costs thereof are high. As a result, costs of the GSM and WIFI dual mode phones are high as well.

### SUMMARY OF THE INVENTION

An embodiment of the invention provides a wireless communication device for processing Voice over Internet Protocol signals. The wireless communication device includes an encoding and decoding module, a central processing unit (CPU), a digital signal processor (DSP), and a wireless communication module. The CPU communicates with the encoding and decoding module for controlling signal flow of the wireless communication device, and includes a multi-channel serial interface (MCSI), an external memory interface (EMI), and a serial peripheral interface (SPI). The DSP communicates with the CPU via the MCSI and the EMI for compressing signals received from the MCSI and decompressing signals received from the EMI. The wireless communication module communicates with the CPU via the SPI for receiving and transmitting voice packets.

Another embodiment of the invention provides a method for processing voice over Internet Protocol (VoIP) signals, for utilization in a wireless communication device including an encoding and decoding module, a central processing unit (CPU) including a multi-channel serial interface (MCSI), an external memory interface (EMI), and a serial peripheral interface (SPI), a digital signal processor (DSP), and a wireless communication module. The method includes converting analog voice signals into digital voice signals, and transmitting the digital voice signals to the CPU; transmitting the digital voice signals to the DSP via the MCSI; compressing the digital voice signals into voice packets, and transmitting the voice packets to the CPU via the EMI; and transmitting the voice packets to the wireless communication module via the SPI.

Other advantages and novel features will become more apparent from the following detailed description when taken in conjunction with the accompanying drawings.

### BRIEF DESCRIPTION OF THE DRAWINGS

FIG. 1 is a schematic diagram of a wireless communication device of an embodiment of the invention.

FIG. 2 shows a schematic diagram of a wireless communication device of another embodiment of the invention.

FIG. 3 shows a flowchart of a method for processing voice over Internet protocol signals of a further embodiment of the invention.

FIG. 4 shows a flowchart of a method for processing voice over Internet protocol signals of a still further embodiment of the invention.

### DETAILED DESCRIPTION OF THE INVENTION

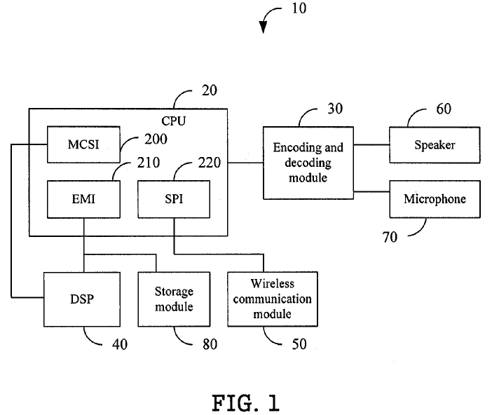

FIG. 1 is a schematic diagram of a wireless communication device 10 of an embodiment of the invention. In the embodiment, the wireless communication device 10 may be a Voice over Internet Protocol (VoIP) device, such as VoIP phones, for processing VoIP signals. The wireless communication device 10 includes a central processing unit (CPU) 20, an encoding and decoding module 30, a digital signal processor (DSP) 40, a wireless communication module 50, a speaker 60, a microphone 70, and a storage module 80.

The CPU 20 for controlling signal flow and signal processing of the wireless communication device 10 communicates with the encoding and decoding module 30. The CPU 20 includes a multi-channel serial interface (MCSI) 200, an external memory interface (EMI) 210, and a serial peripheral interface (SPI) 220. The DSP 40 communicates with the CPU 20 through the MCSI 200 and the EMI 210. The DSP 40 is for compressing and decompressing. In the embodiment, the DSP 40 compresses signals received from the MCSI 200 of the CPU 20, and decompresses signals received from the EMI 210 of the CPU 20. The wireless communication module 50 communicates with the CPU 20 through the SPI 220, and receives and transmits voice packets. In the embodiment, a clock signal line of the SPI 220 is connected to the wireless communication module 50 via a delay circuit (not shown).

The speaker 60 communicates with the encoding and decoding module 30 for receiving analog voice signals and playing the analog voice signals. The microphone 70 converts speech into analog voice signals and transmits the analog voice signals to the encoding and decoding module 30.

When a user speaks into the microphone 70, the microphone 70 converts the speech into analog voice signals, and transmits the analog voice signals to the encoding and decoding module 30. The encoding and decoding module 30 receives the analog voice signals, converts the analog voice signals into digital voice signals, and transmits the digital voice signals to the CPU 20. The CPU 20 receives the digital voice signals, and transmits the digital voice signals to the DSP 40 via the MCSI 200. The DSP 40 receives the digital voice signals, compresses the digital voice signals to voice packets, and transmits the voice packets to the CPU 20 via the EMI 210. The CPU 20 receives the voice packets, and transmits the voice packets to the wireless communication module 50 via the SPI 220. The wireless communication module 50 transmits the voice packets to another device communicating with the wireless communication device 10.

When the wireless communication module 50 receives voice packets from the device communicating with the wireless communication device 10, the wireless communication module 50 transmits the voice packets to the CPU 20 via the SPI 220. The CPU 20 transmits the voice packets to the DSP 40 via the EMI 210. The DSP 40 decompresses the voice packets to digital voice signals, and transmits the digital voice signals to the CPU 20 via the MCSI 200. The CPU 20 then transmits the digital voice signals to the encoding and decoding module 30. The encoding and decoding module 30 decodes the digital voice signals to analog voice signals, and transmits the analog voice signals to the speaker 60 to be played.

In alternative embodiments, the encoding and decoding module 30 further supplies power to the wireless communication device 10.

The storage module 80 communicates with the CPU 20 via the EMI 210 for saving system application programs of the wireless communication device 10.

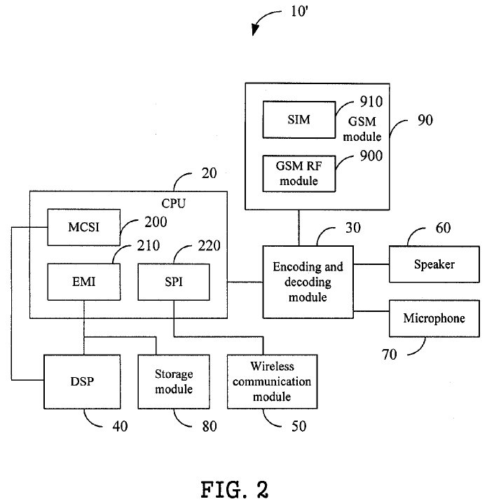

FIG. 2 is a schematic diagram of a wireless communication device 10′ of another embodiment of the invention. In the embodiment, the wireless communication device 10′ may be a global system for mobile communications (GSM) and wireless fidelity (WIFI) dual mode phone. The wireless communication device 10′ further includes a GSM module 90. Descriptions of the other modules are the same as the wireless communication device 10, and thus omitted.

The GSM module 90 for receiving and transmitting GSM signals communicates with the encoding and decoding module 30. In the embodiment, the GSM module 90 includes a GSM radio frequency (RF) module 900 and a subscriber identity module (SIM) 910. The GSM RF module 900 is for receiving and transmitting GSM RF signals and converting between base frequency signals and GSM RF signals, and communicates with the encoding and decoding module 30. The SIM 910 saves GSM data of users of the wireless communication device 10′, such as, GSM phone numbers.

In the embodiment, the encoding and decoding module 30 further communicates with the SIM 910 and converts the base frequency signals from analog signals to digital signals and from digital signals to analog signals.

In the embodiment, processing of voice signals of the wireless communication device 10′ is the same as the processing of voice signals of the wireless communication device 10, therefore descriptions are omitted. When the GSM RF module 900 receives GSM RF signals, the GSM RF module 900 converts the GSM RF signals into analog base frequency signals, and transmits the analog base frequency signals to the encoding and decoding module 30. The encoding and decoding module 30 converts the analog base frequency signals into digital base frequency signals, and transmits the digital base frequency signals to the CPU 20. The CPU 20 converts the digital base frequency signals into digital voice signals, and transmits the digital voice signals to the encoding and decoding module 30. Then the encoding and decoding module 30 converts the digital voice signals into analog voice signals, and transmits the analog voice signals to the speaker 60 to be played.

When a user speaks into the microphone 70, the microphone 70 converts the speech into analog voice signals, and transmits the analog voice signals to the encoding and decoding module 30. The encoding and decoding module 30 receives the analog voice signals, converts the analog voice signals into digital voice signals, and transmits the digital voice signals to the CPU 20. The CPU 20 converts the digital voice signals into digital base frequency signals, and transmits the digital base frequency signals to the encoding and decoding module 30. The encoding and decoding module 30 converts the digital base frequency signals into analog base frequency signals, and transmits the analog base frequency signals to the GSM RF module 900. The GSM RF module 900 converts the analog base frequency signals into GSM RF signals to be sent out.

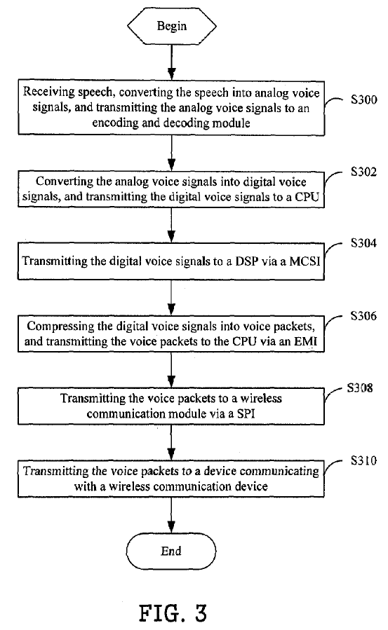

FIG. 3 is a flowchart of a method for processing VoIP signals of an embodiment of the invention. In the embodiment, the wireless communication device 10 transmits signals to the device communicating with the wireless communication device 10. In step S300, the microphone 70 picks up speech from users, converts the speech into analog voice signals, and transmits the analog voice signals to the encoding and decoding module 30. In step S302, the encoding and decoding module 30 converts the analog voice signals into digital voice signals, and transmits the digital voice signals to the CPU 20. In step S304, the CPU 20 transmits the digital voice signals to the DSP 40 via the MCSI 200. In step S306, the DSP 40 compresses the digital voice signals into voice packets, and transmits the voice packets to the CPU 20 via the EMI 210. In step S308, the CPU 20 transmits the voice packets to the wireless communication module 50 via the SPI 22. In step S310, the wireless communication module 50 transmits the voice packets to the device communicating with the wireless communication device 10.

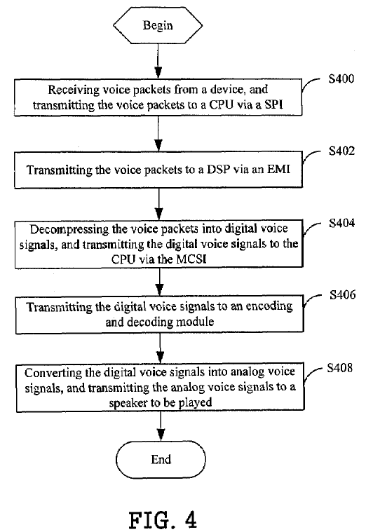

FIG. 4 is a flowchart of a method for processing VoIP signals of another embodiment of the invention. In the embodiment, the wireless communication device 10 receives signals from the device communicating with the wireless communication device 10. In step S400, the wireless communication module 50 receives voice packets from the device communicating with the wireless communication device 10, and transmits the voice packets to the CPU 20 via the SPI 220. In step S402, the CPU 20 transmits the voice packets to the DSP 40 via the EMI 210. In step S404, the DSP 40 decompresses the voice packets into digital voice signals, and transmits the digital voice signals to the CPU 20 via the MCSI 200. In step S406, the CPU 20 transmits the digital voice signals to the encoding and decoding module 30. In step S408, the encoding and decoding module 30 converts the digital voice signals into analog voice signals, and transmits the analog voice signals to the speaker 60 to be played.

The CPU 20 and the DSP 40 can process VoIP signals, such that the wireless communication devices 10 and 10′ have VoIP functions without using an expensive VoIP chip, and therefore, the CPU 20 and the DSP 40 can use inexpensive conventional chips respectively, providing lower development costs.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A wireless communication device, for processing Voice over Internet Protocol signals, comprising:
an encoding and decoding module;
a central processing unit (CPU), communicating with the encoding and decoding module, for controlling signal flow of the wireless communication device, the CPU comprising a multi-channel serial interface (MCSI), an external memory interface (EMI), and a serial peripheral interface (SPI);
a digital signal processor (DSP), communicating with the CPU via the MCSI and the EMI, for compressing signals received from the MCSI and decompressing signals received from the EMI; and
a wireless communication module, communicating with the CPU via the SPI, for receiving and transmitting voice packets.

2. The wireless communication device of claim 1, further comprising a speaker, communicating with the encoding and decoding module for receiving analog voice signals from the encoding and decoding module and playing the analog voice signals.

3. The wireless communication device of claim 1, further comprising a microphone communicating with the encoding and decoding module for converting speech into analog voice signals and transmitting the analog voice signals to the encoding and decoding module.

4. The wireless communication device of claim 3, wherein the encoding and decoding module is used for receiving the analog voice signals and converting the analog voice signals into digital voice signals.

5. The wireless communication device of claim 4, wherein the CPU is used for receiving the digital voice signals and transmitting the digital voice signals to the DSP via the MCSI.

6. The wireless communication device of claim 5, wherein DSP is used for receiving the digital voice signals, compressing the digital voice signals into voice packets, and transmitting the voice packets to the CPU via the EMI.

7. The wireless communication device of claim 6, wherein the CPU is further used for transmitting the voice packets to the wireless communication module via the SPI.

8. The wireless communication device of claim 1, wherein the wireless communication device comprises a global system for mobile communications (GSM) and wireless fidelity (WIFI) dual mode phone.

9. The wireless communication device of claim 8, further comprising a GSM module communicating with the encoding and decoding module, for receiving and transmitting GSM signals.

10. The wireless communication device of claim 9, wherein the GSM module comprises:
a GSM radio frequency module, communicating with the encoding and decoding module for receiving and transmitting GSM radio frequency signals and converting between base frequency signals and the GSM RF signals; and
a subscriber identity module (SIM), communicating with the encoding and decoding module for saving GSM data.

11. The wireless communication device of claim 10, wherein the encoding and decoding module is further used for communicating with the SIM and for converting the base frequency signals from analog signals to digital signals and from digital signals to analog signals.

12. The wireless communication device of claim 1, further comprising a storage module, communicating with the CPU via the EMI for saving system programs of the wireless communication device.

13. A method for processing voice over Internet Protocol (VoIP) signals, for utilization in a wireless communication device comprising an encoding and decoding module, a central processing unit (CPU) comprising a multi-channel serial interface (MCSI), an external memory interface (EMI), and a serial peripheral interface (SPI), a digital signal processor (DSP), and a wireless communication module, the method comprising:
converting analog voice signals into digital voice signals, and transmitting the digital voice signals to the CPU;
transmitting the digital voice signals to the DSP via the MCSI;
compressing the digital voice signals into voice packets, and transmitting the voice packets to the CPU via the EMI; and
transmitting the voice packets to the wireless communication module via the SPI.

14. The method for processing VoIP signals of claim 13, further comprising steps of:
receiving speech, converting the speech into the analog voice signals, and transmitting the analog voice signals to the encoding and decoding module.

15. The method for processing VoIP signals of claim 13, further comprising steps of:
transmitting the voice packets to a device communicating with the wireless communication device.

16. The method for processing VoIP signals of claim 13, further comprising steps of:
receiving other voice packets from a device communicating with the wireless communication device, and transmitting the other voice packets to the CPU via the SPI;
transmitting the other voice packets to the DSP via the EMI;
decompressing the other voice packets into digital voice signals, and transmitting the digital voice signals to the CPU via the MCSI;
transmitting the digital voice signals to the encoding and decoding module; and
converting the digital voice signals into analog voice signals, and transmitting the analog voice signals to a speaker to be played.

17. A method for processing voice over Internet Protocol (VoIP) signals, comprising the steps of:
modularizing a digital signal processor (DSP) independent from a central processing unit (CPU) which controls signal processing;
signal-communicating said DSP with said CPU through a multi-channel serial interface (MCSI) and an external memory interface (EMI);
retrieving voice signals to said CPU;
transmitting said voice signals from said CPU to said DSP via said MCSI;
generating digitally transmissible voice packets out of said voice signals by said DSP; and
transmitting said voice packets back to CPU via said EMI.

18. The method for processing VoIP signals of claim 17, further comprising the step of converting analog voice signals into digital voice signals before said CPU retrieves said digital voice signals.
